(19) United States
(12) Patent Application Publication
(10) Pub. No.: US 2025/0138583 A1
(43) Pub. Date: May 1, 2025

(54) Tabletop Display With Secure Battery and Attachment

(71) Applicant: Waev Technologies, Inc., Waxhaw, NC (US)

(72) Inventor: Jake Corday, Waxhaw, NC (US)

(21) Appl. No.: 18/494,063

(22) Filed: Oct. 25, 2023

(51) Int. Cl. G06F 1/16

(52) U.S. Cl. CPC G06F 1/1635; G06F 1/1632; G06F 1/1679; G06F 1/1683

(57) ABSTRACT

The tabletop display with secure battery and attachment is a point of sale advertising platform comprising a display unit, a battery, and a mount. The display unit may be mounted to a mounting surface in a business such that the display unit faces patrons of the business and may present advertising and other engaging content on a display screen as static images, motion video, or both. The tabletop display comprises security features to deter theft and/or vandalism. The display unit may be coupled to the mount by a pair of mounting clips that are accessible only with the battery removed from the display unit. A pair of locking tabs on the battery may engage battery lock apertures on a display unit housing such that a key is required in order to remove the battery. A guide rail may guide the battery for ease of battery installation.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Many businesses, especially restaurants and bars, attempt to display advertising to patrons using static printed signs such as tent cards, coasters, acrylic sign holders, sign display clips, and so on. Such displays may look amateurish if the signage is printed in house and may quickly become stagnant due to the printing lead-time if printed professionally.

Static printed signs may not capture the attention of the patrons. Static printed signs offer minimal opportunity for interaction between patrons and the sign-limited essentially to scanning a QR code.

Static printed signage may be difficult to update quickly when necessary to take advantage of fast-breaking trends and limited-time offers. Static printed signage is not able to present full-motion video. Static printed signage may fail to actively engage visitors to the business.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an isometric view of a display unit consistent with certain embodiments of the present invention.

FIG. 2 is a front view of a display unit consistent with certain embodiments of the present invention.

FIG. 3 is a rear view of a display unit consistent with certain embodiments of the present invention.

FIG. 4 is a left side view of a display unit consistent with certain embodiments of the present invention.

FIG. 5 is a right side view of a display unit consistent with certain embodiments of the present invention.

FIG. 6 is a top view of a display unit consistent with certain embodiments of the present invention.

FIG. 7 is an isometric view of a battery consistent with certain embodiments of the present invention.

FIG. 8 is a front view of a battery consistent with certain embodiments of the present invention.

FIG. 9 is a rear view of a battery consistent with certain embodiments of the present invention.

FIG. 10 is a side view of a battery consistent with certain embodiments of the present invention.

FIG. 11 is a top view of a battery consistent with certain embodiments of the present invention.

FIG. 12 is a bottom view of a battery consistent with certain embodiments of the present invention.

FIG. 13 is an isometric view of a mount consistent with certain embodiments of the present invention.

FIG. 14 is a front view of a mount consistent with certain embodiments of the present invention.

FIG. 15 is a side view of a mount consistent with certain embodiments of the present invention.

FIG. 16 is a top view of a mount consistent with certain embodiments of the present invention.

FIG. 17 is an exploded view of a mount, a display, a battery, and a key consistent with certain embodiments of the present invention.

FIG. 18 is a top view of a display unit consistent with certain embodiments of the present invention and illustrating the pair of mounting clips in the clip unlocked position.

FIG. 19 is a top view of a display unit consistent with certain embodiments of the present invention and illustrating the pair of mounting clips in the clip locked position.

FIG. 20 is an isometric view of a key consistent with certain embodiments of the present invention.

FIG. 21 is an isometric view of an alternative embodiment of a mount consistent with certain embodiments of the present invention.

FIG. 22 is an isometric view of a battery and a key consistent with certain embodiments of the present invention illustrating the locking tabs in an extended state.

FIG. 23 is an isometric view of a battery and a key consistent with certain embodiments of the present invention illustrating the locking tabs in a retracted state.

FIG. 24 is an isometric view of a battery and a key consistent with certain embodiments of the present invention illustrating the locking tabs in an extended state.

FIG. 25 is an isometric view of a battery and a key consistent with certain embodiments of the present invention illustrating the locking tabs in a retracted state.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The tabletop display with secure battery and attachment (hereinafter invention) may be a point-of-sale (POS) advertising platform comprising a display unit, a battery, and a mount. The display unit may be mounted to a mounting surface in a business such that the display unit is proximal to patrons of the business. As non-limiting examples, the mounting surface may be a restaurant table, a bar top, a high-top table, a counter top, or other horizontal surface and the business may be a restaurant or a bar. The display unit may be positioned such that a display screen faces the patrons. Advertising and other engaging content may be displayed on the display screen as static images, motion video, or both. The content may be selected to increase sales, increase brand affinity, and generate awareness of new brands, products lines, and/or campaigns. As a non-limiting example, the content may encourage downloading a mobile application by presenting an invitation with a QR code that links to the mobile application download site. As a further non-limiting example, the content may facilitate sweepstakes and giveaways.

Throughout this document, “front” refers to the side of an element that faces the patrons.

The invention may seamlessly integrate with an existing business infrastructure via a wireless network. As non-limiting examples, software executing on the display unit may communicate with the existing business infrastructure via the wireless network such that point-of-sale terminals, kitchen displays, receipt printers, and other in-store IT devices may be utilized by the display unit. The content to be shown on the display unit may be edited at an office computer or server located, by way of example and not of limitation, in a manager's office and may be downloaded to the display unit via the wireless network. Alternatively, the content may be created at a remote location such as a corporate office on a remote, networked server and downloaded to the office computer for dissemination to the display units.

The invention may comprise security features to deter theft and/or vandalism. The display unit may be coupled to the mount by a pair of mounting clips that are accessible only with the battery removed from the display unit. A pair of locking tabs on the battery may engage battery lock apertures on a display unit housing to secure the battery to the housing such that a key is required in order to remove the battery.

The display unit may comprise the display unit housing with the display screen coupled to the front of the display unit housing and a battery well for retaining the bottom of the battery located at the bottom rear of the display unit housing. The battery well may also be where the display unit couples to the mount. Specifically, the battery well may comprise mounting apertures located at the bottom of the battery well. A pair of security posts located on the mount may extend up through the mounting apertures and into the battery well. The pair of mounting clips may be slidably coupled to the bottom of the battery well and may be moved laterally to capture the pair of security posts to secure the battery such that the display unit may not be lifted from the mount.

The display screen may be adapted to display static and/or moving color images to the patrons. As non-limiting examples, the display screen may utilize LCD technology, TFT technology, LED technology, OLED technology, or any combination thereof. In a preferred embodiment, the display screen may be oriented in portrait mode.

The rear of the display unit housing may comprise a guide rail that may be operable to align the battery during battery installation. The guide rail may be vertically-oriented and may engage a guide slot on the battery such that the battery may be held above the rear of the display unit and lowered into the battery well with the guide rail aligning the battery with the battery well when the battery is inserted into the battery well.

The rear wall of the display unit housing may comprise the battery lock apertures. In a preferred embodiment, the battery lock apertures are positioned laterally on the top one quarter of the rear of the display unit housing. A pair of battery locking tabs are positioned on each battery housing and oriented such that they come into contact with the battery lock apertures when the battery is inserted into the battery well. Installation of the battery is thus very easy since a user need only hold the battery above the rear of the display unit and lower the battery such that the guide rail guides the battery into the battery well until the pair of locking tabs on the battery engage the battery lock apertures on the display unit housing.

The display unit may comprise a light bar that may be located on the top of the display unit. The light bar may be controlled by a microprocessor controller located within the display unit. In some embodiments, the microprocessor controller may illuminate and extinguish the light bar, may determine the intensity of the light bar when the light bar is illuminated, may determine the color of the light bar when the light bar is illuminated, may blink the light bar on and off, may be programmed to present pre-configured light patterns and colors, or any combination thereof. As non-limiting examples, the light bar may be adapted to indicate that the patrons require attention, have completed a payment, present a message from the restaurant, or have won a contest. As further non-limiting examples, the light bar may be operable to indicate situations where the display unit or the battery require servicing such as battery low, no network connection, or internal self-test failed. The specific reason for illuminated the light bar may be pre-configured and may be apparent based upon the color of the light bar, the intensity of the light bar, the blink pattern of the light bar, or any combination thereof.

The microprocessor controller may be a computer processor that incorporates the functions of a central processing unit in the form of one or more integrated circuit boards and/or chips. The microprocessor controller may comprise one or more memory modules and one or more I/O ports, either incorporated into the microprocessor controller or as separate integrated circuits. The one or more I/O ports may be operable for the microprocessor controller to monitor and control the display unit.

The display unit may comprise one or more wireless transceivers that may be operable to pass information packets between the microprocessor controller and a remote system through a network communication channel or protocol. As non-limiting examples, the information packets may represent the content to be displayed on the display screen, an update of the software, payment information supplied by the patrons, pre-configured light patterns, status of the display unit and/or the battery, or any combination thereof.

The microprocessor controller may execute any of the software functions that may be stored in the one or more memory modules. The software functions may provide the process steps and commands to control the operation of the display screen, the one or more wireless transceivers, the light bar, and other electronic circuits within the display unit.

In an embodiment, the microprocessor controller may provide control and communication functions including the display of a QR code that a user may scan to pull up a menu that is specific to the table associated with the device to which the device is attached. Additionally, the controller, through the NFC communications channel, may communicate with the display device to display a poll to a user. Where the user may input their choices on the poll through a touch sensitive surface of the display portion of the display device. In this manner, the system may capture user feedback that is specific to an identified table in real-time. The user feedback may be sent to a manager of the business in which the display device is installed for resolution or information to the manager. Additionally, the device may transmit a QR code to a web service, such as Google, to present this information to other users.

In an embodiment, the control software operative on said microprocessor controller may be integrated with a Point-of-Sale (POS) system active within the business in which the display device is installed. The integration with the POS may permit the business to activate a Machine Learning (ML) algorithm that creates multiple versions of advertisements for services or products provided by the business and transmit a different version of said advertisements to each table, desk, or position containing an active display device such that the user associated with each active display device may receive a different advertisement.

Information may be collected by the ML algorithm in real time from each active display device. The ML algorithm may also collect information on which ad and from which active display device an advertisement resulted in a purchase activity for the good or service advertised. The ML algorithm may analyze the collected information to create a purchase optimization process utilizing the ads that generated purchase activity in real time for presentation to users of active display devices at later times and/or at other locations for the business. The ML algorithm may also be active to optimize the scheduling of an individual's interaction or the timing of offerings of goods and services to the user so as to create a smooth and seamless delivery of such offerings during the individual user's visit to the business.

In an embodiment, the data server associated with the business and in communication with the display device may be active to provide analysis of individual users who have previously used the system of the display device and are either registered with or known to the system. The information on each individual known user may be shared between the data server and the display device system. When a known or registered user checks-in again with the display device system through an individual display device, this information is shared with the business data server. The data server and the display device system, through a separate system data server, may review the history of check-ins and use of the display device system. The data server associated with the display device system may analyze the historic record of interactions between the individual user and the display device system, including past orders, purchases, comments, games played, information provided, and staff interactions along with such information as may be provided by the data server associated with the business. The analysis may focus on what may be provided to the individual user in terms of predictions, information, recommendations, and options to optimize the experience of the individual user based upon the analysis of the aggregated past history information. The recommendations, predictions, and information may be provided to business management, servers, and other business representatives to supply the individual user with known preferences, or to supply new experiences, information, or products that the individual user may not have tried before but fit with the analysis of preferences expressed by the individual user in past interactions with the display device system, the business, or both. This experience enhancement and optimization may occur in real time as the individual user is actively using the display device system.

As a portion of the experience optimization the manager or other employee of the business may provide an individual user with real-time flash deals or other advertisements and specials. These deals may or may not be associated with the ML analysis of the individual user's past history and experience optimization.

The display device system may also be active to track when users plug mobile devices, such as mobile phones, iPads, tablets, or other mobile devices into the USB or other port provided in the casing of the display device.

The display device may also be used in conjunction with the business data server to formulate and present messages to the user indicating the fact that the business is hiring new associates. The display device may display the job posting and provide the individual with the option to complete an application during the individual's visit to the business. The display device system may then formulate a message to the management of the business about the individual's interest and attach a copy of the input application provided by the individual.

The one or more memory modules may comprise read/write memory for storing parameters that may change or which are temporary in nature and non-volatile memory for storing information that must persist across power interruptions, such as the control software. As a non-limiting example, the non-volatile memory may comprise FLASH memory.

The one or more wireless transceivers may comprise at least one Wi-Fi transceiver, one or more Near Field Communication (NFC) transceivers, or both. As a non-limiting example, the at least one Wi-Fi transceiver may enable communication between the display unit and the network capable remote system using IEEE 802.11 protocols for the purpose of updating the content, updating the software, notifying the existing business infrastructure of a completed payment, and conveying status of the display unit to the remote system. As a further non-limiting example, the one or more NFC transceivers may be operable to read a payment card that is proximal to, or in contact with, the display unit.

The display unit may comprise one or more USB ports such that the patrons may recharge personal devices. In a preferred embodiment, the one or more USB ports may comprise a USB-C port and a USB-A port located on opposite lateral sides of the display unit.

In some embodiments, the display screen of the display unit may comprise a touch overlay so that the patrons may interact with the display unit. By way of example and not of limitation, the content may comprise games and/or contests where the patrons may play to win prizes, may comprise customer satisfaction surveys, may permit order entry and drink refill requests by the patrons, and may facilitate payment processing.

The touch overlay may be a touch-sensitive interface coupled to the display unit in front of the display screen. The touch overlay may be substantially transparent such that the display screen is visible through the touch overlay. The touch overlay may be adapted to register contacts on the touch overlay by the patrons and to report when and where contact occurs to the microprocessor controller. The software may map the location of the contact with touch targets presented on the display screen to determine what action is appropriate based upon the contact. As non-limiting examples, the touch overlay may utilize capacitive technologies, resistive film technologies, surface acoustic wave technologies, infrared technologies, piezoelectric technologies, acoustic pulse technologies, or any combination thereof.

The battery may comprise one or more energy-storage devices. The battery may be source of electrical energy to operate the display screen, the microprocessor controller, the one or more memory modules, the one or more I/O ports, the one or more wireless transceivers, the one or more USB ports, the light bar, and the touch overlay. The battery may be detached from the battery well of the display unit and removed for recharging.

In a preferred embodiment, the battery may be the shape of a half cylinder and may detachably couple to the display unit by dropping into the battery well. A first power connector located in the battery well may electrically couple to a second power connector located on the bottom of the battery to transfer electrical energy from the battery to the display unit.

The front of the battery may comprise the guide slot which engages the guide rail on the rear of the display unit housing. The guide slot of the battery may match the shape of the guide rail including the narrowing at the top of the guide slot. The battery may be prevented from moving forward, rearward, and laterally to the left or right by the display unit housing, the battery well, and by the guide rail engaging the guide slot.

The battery may comprise the pair of locking tabs extending from the rear or back surface of the battery casing to secure the battery into the battery well and prevent lifting the battery out of the battery well. The pair of locking tabs may be spring-loaded moveable tabs that may pivot, slide, or otherwise move into the battery casing as the pair of locking tabs press against the display unit housing during installation of the battery. Once the battery has been lowered into the battery well, the pair of locking tabs may reach the vertical level of the battery lock apertures on the rear of the display unit housing and may extend from the battery casing and into the battery lock apertures. With the battery locking tabs extending into the battery lock apertures, mechanical interference between the pair of battery locking tabs and the display unit housing may then prevent the battery from being lifted out of the battery well.

The display unit may comprise a pair of release apertures located on the top of the battery casing and above the pair of locking tabs into which a release key may be inserted. The pair of locking tabs may be forced to move into the battery to release the battery for removal from the display unit by pressing the release key into the pair of release apertures.

The battery may comprise a pair of finger handles located on opposite lateral sides of the battery. The pair of finger handles may be adapted to be grasped by the user to secure the grip of the individual on the battery casing while lifting the battery from the display unit.

The battery may comprise a charge level indicator located on the upper rear center of the battery. The charge level indicator may be a single, multi-color LED that is operable to display the current charge level of the battery. As non-limiting examples, the charge level indicator may be illuminated green when the remaining charge in the battery is above or equal to a first battery threshold, the charge level indicator may be illuminated yellow when the remaining charge in the battery is above or equal to a second battery threshold but below the first battery threshold, and the charge level indicator may be illuminated red when the remaining charge in the battery is below the second battery threshold. In some embodiments, the charge level indicator may blink while the battery is recharging.

The mount may detachably couple to a mounting surface and may retain the display unit in place on the mounting surface. The mount may couple to the side of the mounting surface that is away from the patrons such that the display unit may be oriented to present the display screen to the patrons.

The mount may comprise a C-shaped armature, a top alignment guide, and a moveable jaw. The C-shaped armature may comprise a top arm, a bottom arm, and a vertical arm that bracket the mounting surface. The mount may clamp onto the mounting surface with the mounting surface captured between the bottom of the top arm and the moveable jaw that is adjustably coupled to the bottom arm.

The top of the top arm may comprise the pair of security posts. The pair of security posts may be laterally separated by a distance which matches the distance between the mounting apertures in the battery well. The pair of security posts may project upwards and may be of sufficient length to extend through the mounting apertures in the battery well when the display unit is placed onto the mount. The pair of mounting clips are maintained in a clip unlocked position during attachment to the mounting surface. After attachment of the display unit to the mount, the pair of mounting clips may engage the pair of security posts when the pair of mounting clips are moved to a clip locked position and may prevent lifting of the display unit from the mount.

Specifically, an individual security post selected from the pair of security posts may comprise a post upright and a top cap. The post upright may comprise flattened front and rear surfaces. The distance between the flattened front and rear surfaces may be less than the diameter of the top cap. The width of a gap in the pair of mounting clips may be greater than the distance between the flattened front and rear surfaces but less than the diameter of the top cap. Therefore, with the pair of security posts inserted through the mounting apertures the pair of mounting clips may slide past the pair of security posts to the clip locked position however if an effort is made to lift the display unit from the mount mechanical interference between the top caps and the pair of mounting clips may prevent removal of the display unit.

The top alignment guide may couple to the top of the top arm to align the display unit. The top of the top alignment guide may be shaped to match the bottom of the display unit.

The bottom arm of the C-shaped armature may comprise a threaded aperture that is vertically oriented. The moveable jaw may adjustably couple to the bottom arm via the threaded aperture.

The moveable jaw may comprise a jaw pad, a threaded shaft, a captive tightening nut, and a lock nut. The jaw pad may be coupled to the top of the threaded shaft. The threaded shaft may be screwed into the threaded aperture in the bottom arm and lowered such that the distance between the top of the jaw pad and the bottom of the top arm is larger than the thickness of the mounting surface. The mount may then be positioned on the mounting surface by inserting the edge of the mounting surface into the C-shaped armature between the jaw pad and the top arm. Once the mount is pushed onto the mounting surface to the point where the vertical arm of the C-shaped armature is against the mounting surface, the moveable jaw may be unscrewed to raise the jaw pad. The jaw pad may be pressed up against the bottom of the mounting surface. The moveable jaw may comprise the captive tightening nut located at the bottom of the jaw pad to assist in tightening the moveable jaw against the bottom of the mounting surface. Once the moveable jaw is secured against the bottom of the mounting surface, the lock nut on the threaded shaft may be lowered to press against the bottom arm.

The mount may comprise a bottom cover that may couple to the bottom arm to cover the bottom of the threaded shaft which may otherwise be exposed beneath the bottom arm.

The battery release key may be inserted into the pair of release apertures located on the top of the battery to release the pair of locking tabs from the battery lock apertures so that the battery may be lifted from the display unit. The key may comprise a pair of release pins that are separated by a crossbar handle. The pair of release pins may be parallel and separated by a distance that matches the separation distance between the pair of release apertures on the battery. The insertion of both pins of the pair of release pins at the same time is required in order to unlock the battery so that this security feature may not be foiled by inserting a single straight pin or other straight object into one of the pair of release apertures. In addition, use of the key to unlock the battery enhances another security feature which requires the battery to be removed to reposition the pair of mounting clips before the display unit may be removed from the mount.

In a preferred embodiment, the mount may orient the display unit to face directly forward. In some embodiments, the orientation of the pair of security posts and the top alignment guide on the top arm may be rotated about a vertical axis to turn the display unit to an off-center viewing angle. As a non-limiting example, the pair of security posts and the top alignment guide may be rotated about a vertical axis by 45 degrees to provide a better viewing angle for the patrons in some environments. Additionally, other alignment angles may be selected and used to rotate the display unit to a viewing angle between about 0 and about 180 degrees to accommodate the position of patrons relative to the display unit.

In some embodiments, a battery caddy may be operable to hold the batteries while the batteries are recharging. The battery caddy may have a separate charging slot for a plurality of batteries. In a preferred embodiment, the battery caddy may have six to eight such charging slots. The battery caddy may be attached to an electrical outlet and provide the proper charging amperage to each charging slot to charge each of the batteries that have been inserted into battery slots within the battery caddy simultaneously. The battery caddy may be detached from the electrical outlet with batteries retained within the battery slots. Once detached, the battery caddy may then be carried to the display units to exchange discharged batteries with freshly recharged batteries.

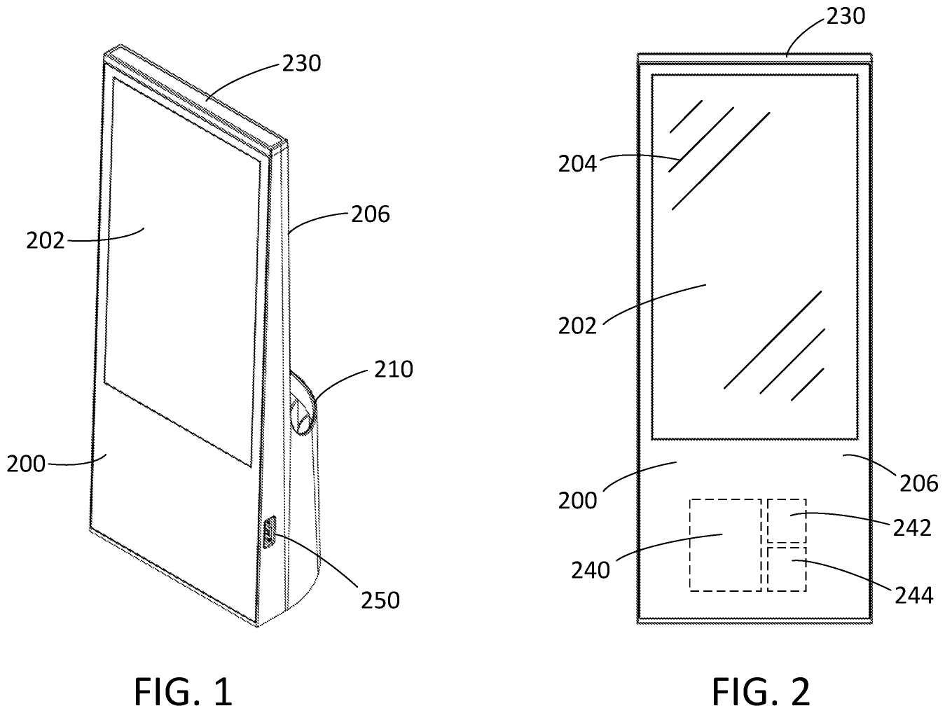

Turning now to FIG. 1, the figure shows an isometric view of a display unit 200. A display unit housing 206 may house a display screen 202 that may be oriented to display advertising and other content to patrons. A light bar 230 may be located at the top of the display unit 200 and may be operable to call attention to the display unit 200 when the light bar 230 is activated. A battery well 210 may be visible at the rear of the display unit 200 and one or more USB ports 250 may be seen on the lateral sides of the display unit housing 206.

Turning now to FIG. 2, the figure shows a front view of a display unit 200. A display screen 202 may display advertising and other content and, in some embodiments, may comprise a touch overlay 204 such that patrons may interact with the content. A microprocessor controller 240, one or more memory modules 242, and one or more wireless transceivers 244 may be housed within a display unit housing 206. A light bar 230 may be coupled to the top of the display unit 200.

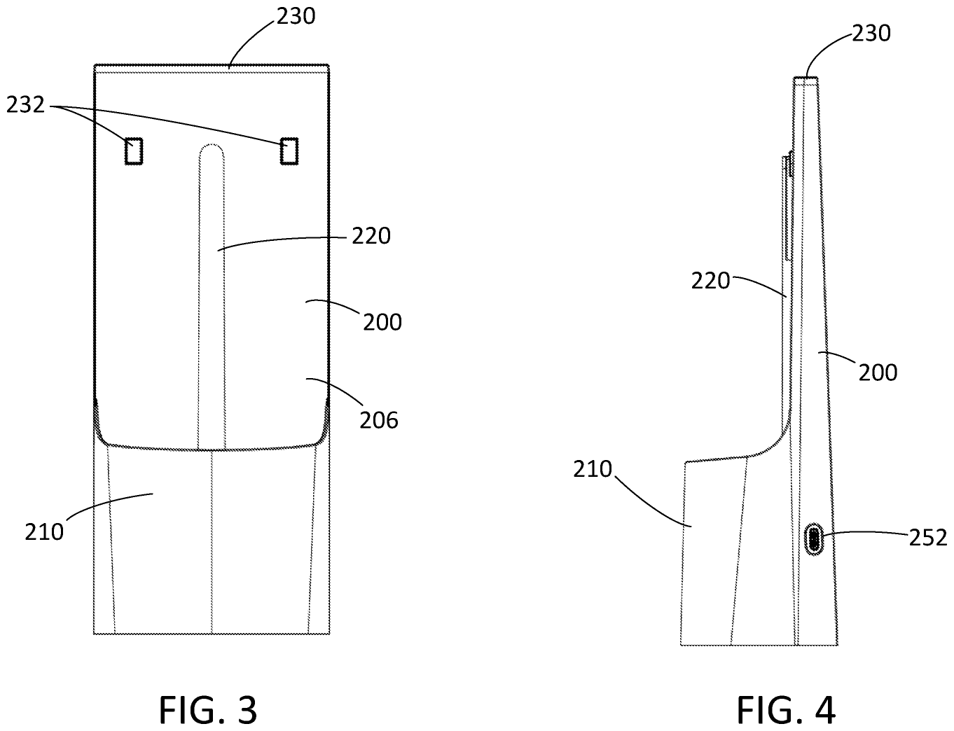

Turning now to FIG. 3, the figure shows a rear view of a display unit 200. A battery well 210 may be located at the bottom rear of a display unit housing 206. The rear of the display unit 200 may also comprise a guide rail 220 and battery lock apertures 232 for guiding and locking a battery.

Turning now to FIG. 4, the figure shows a left side view of a display unit 200. A light bar 230, a guide rail 220, and a battery well 210 are shown along with a USB-C port 252.

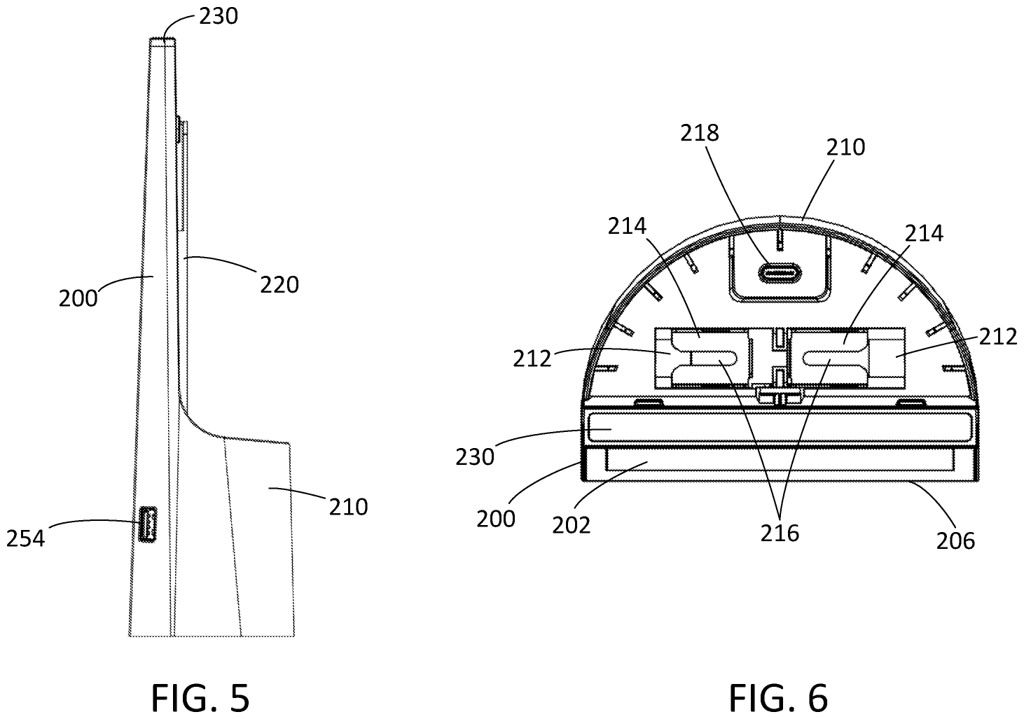

Turning now to FIG. 5, the figure shows a right side view of a display unit 200. A light bar 230, a guide rail 220, and a battery well 210 are shown along with a USB-A port 254.

Turning now to FIG. 6, the figure shows a top view of a display unit 200. A display screen 202 may be seen at the front of the display unit 200 along with a light bar 230 located at the top of the display unit 200. A battery well 210 may extend rearward from the bottom of a display unit housing 206. Mounting apertures 212 located at the bottom of the battery well 210 and a first power connector 218 can be seen adjacent to a pair of mounting clips 214. Gaps 216 in the pair of mounting clips 214 may be apparent in this view.

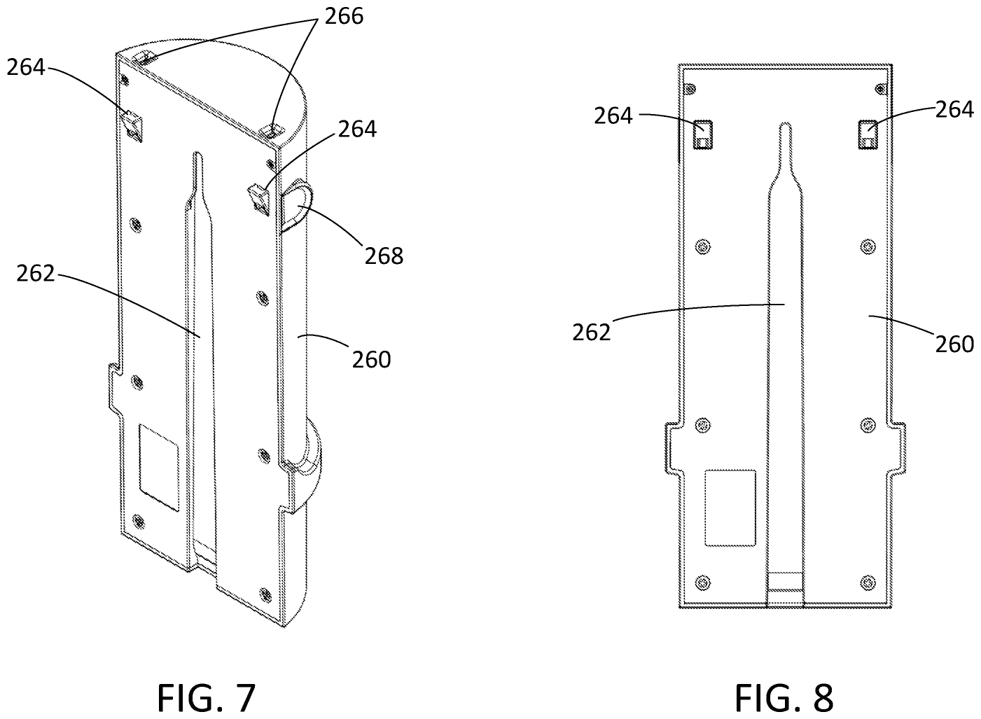

Turning now to FIG. 7, the figure shows an isometric view of a battery 260. The front of the battery 260 may comprise a guide slot 262 and a pair of locking tabs 264. The top of the battery 260 may comprise a pair of release apertures 266. A pair of finger handles 268 may be located on the lateral sides of the battery 260.

Turning now to FIG. 8, the figure shows a front view of a battery 260. A guide slot 262 may be vertically-oriented at the center of the battery 260 with a pair of locking tabs 264 located at the top of the battery 260 on either side of the guide slot 262.

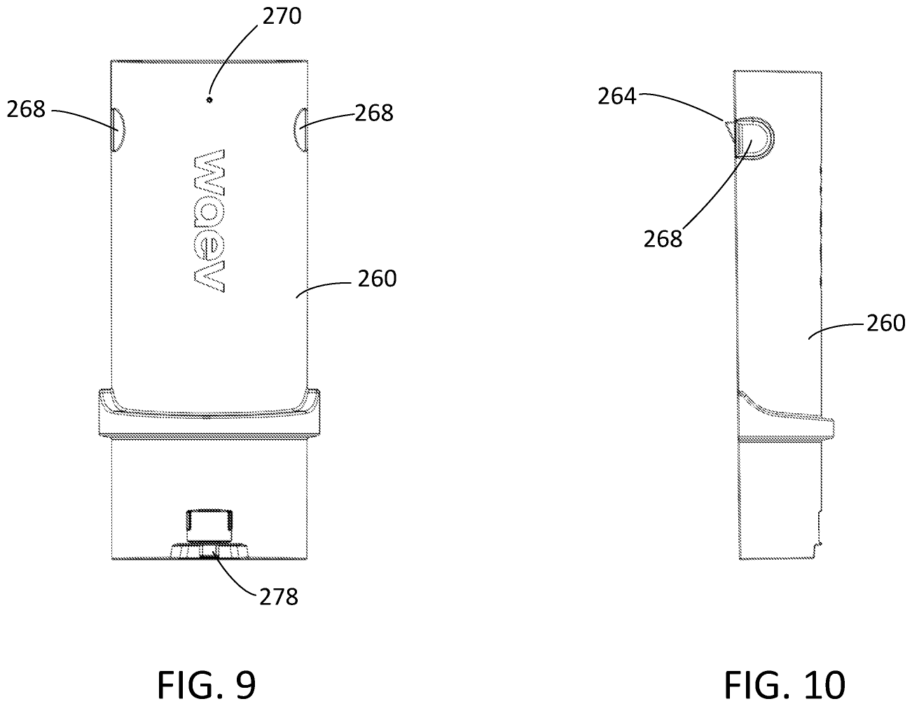

Turning now to FIG. 9, the figure shows a rear view of a battery 260. A pair of finger handles 268 may be located on the lateral sides of the battery 260. A charge level indicator 270 located at the top center of the battery 260 may visually display the charge level of the battery 260. A second power connector 278 may be located at the bottom of the battery 260.

Turning now to FIG. 10, the figure shows a side view of a battery 260 illustrating the locations of a pair of finger handles 268 and a pair of battery locking tabs 264.

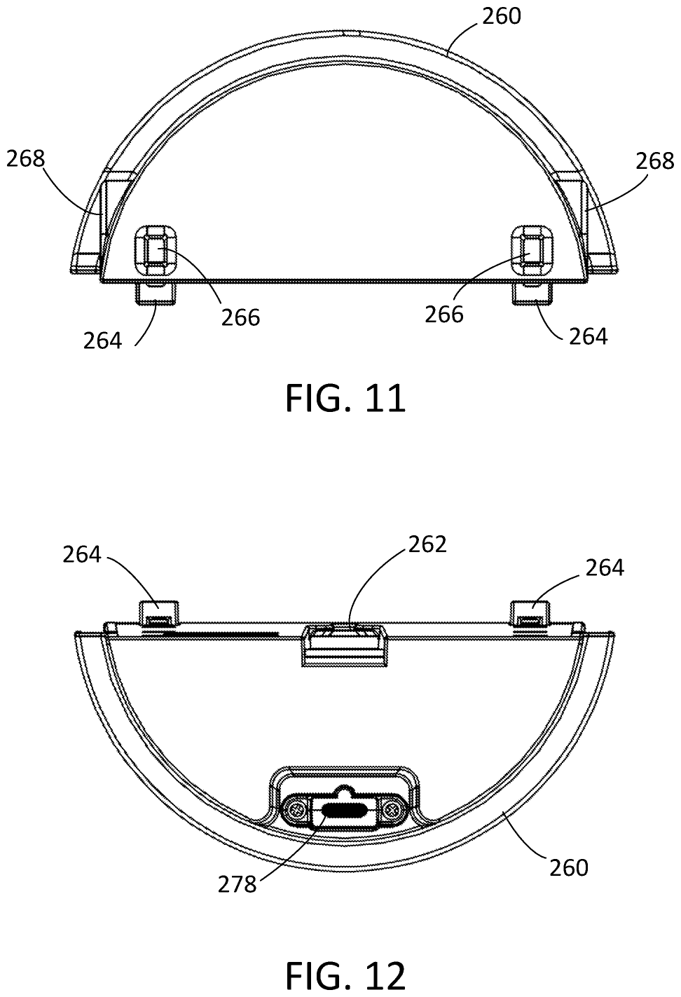

Turning now to FIG. 11, the figure shows a top view of a battery 260. The figure illustrates the location of a pair of finger handles 268 on the lateral sides of the battery 260, a pair of release apertures 266 on the top of the battery casing 260, and a pair of locking tabs 264 on the front of the battery 260.

Turning now to FIG. 12, the figure shows a bottom view of a battery 260 illustrating the location of a pair of locking tabs 264, a guide slot 262, and a second power connector 278.

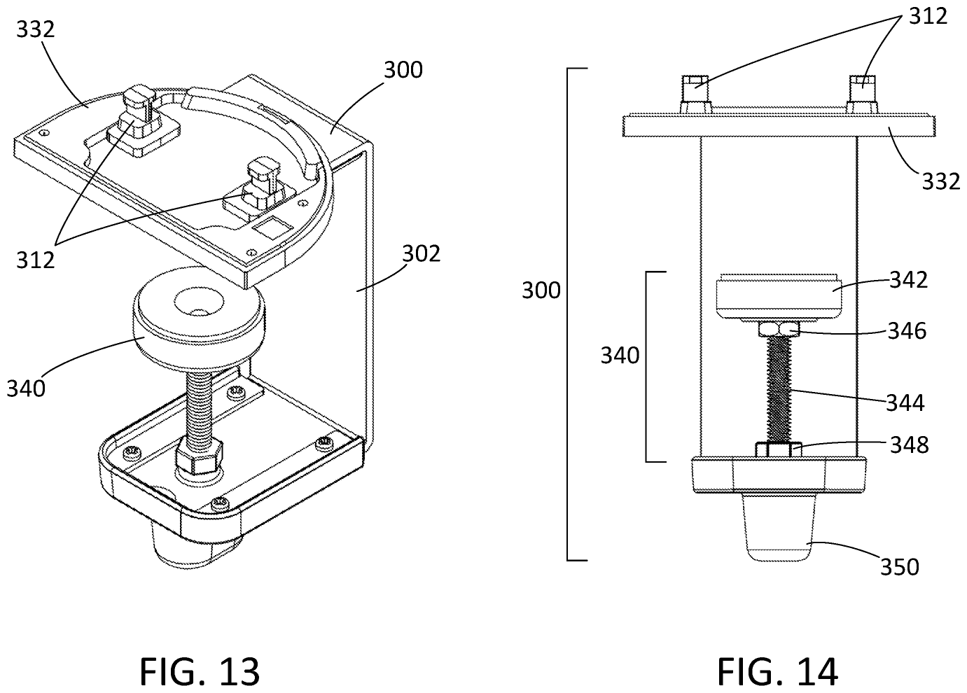

Turning now to FIG. 13, the figure shows an isometric view of a mount 300. A C-shaped armature 302 may define the basic shape of the mount 300. A moveable jaw 340 may be unscrewed to press against the bottom of a mounting surface to secure the mount 300 to the mounting surface. A top alignment guide 332 may assist in aligning a display with the mount 300 such that a pair of security posts 312 may extend up into a battery well.

Turning now to FIG. 14, the figure shows a front view of a mount 300. The mount 300 may comprise a moveable jaw 340 that may be unscrewed to press against the bottom of a mounting surface. The moveable jaw 340 may comprise a jaw pad 342 and a threaded shaft 344. A captive tightening nut 346 captive to the top end of the threaded shaft 344 may be used to tighten the moveable jaw 340 against the mounting surface. A lock nut 348 may be tightened against the bottom of the mount 300 to prevent the moveable jaw 340 from loosening. A bottom cover 350 may shield the bottom of the threaded shaft 344 from exposure. A top alignment guide 332 and a pair of security posts 312 may be located at the top of the mount 300.

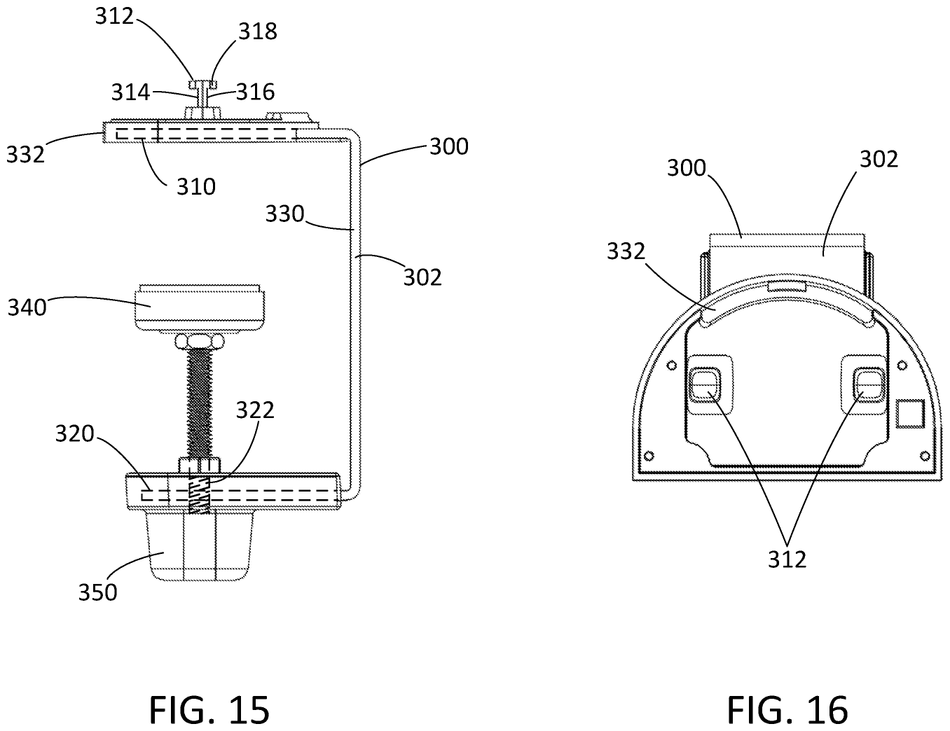

Turning now to FIG. 15, the figure shows a side view of a mount 300. The mount 300 may comprise a C-shaped armature 302 defined by a top arm 310, a bottom arm 320, and a vertical arm 330. The bottom arm 320 may comprise a threaded aperture 322 that a moveable jaw 340 may screw in and out of. A bottom cover 350 may prevent exposure of the bottom of a threaded shaft 344 as the moveable jaw 340 is lowered. A top alignment guide 332 and a pair of security posts 312 may be coupled to the top arm 310. An individual security post selected from the pair of security posts 312 may comprise a post upright 314 and a top cap 318. The post upright 314 may comprise flattened front and rear surfaces 316 on the front and rear sides of the post upright 314.

Turning now to FIG. 16, the figure shows a top view of a mount 300 illustrating the locations of a C-shaped armature 302, a top alignment guide 332, and a pair of security posts 312.

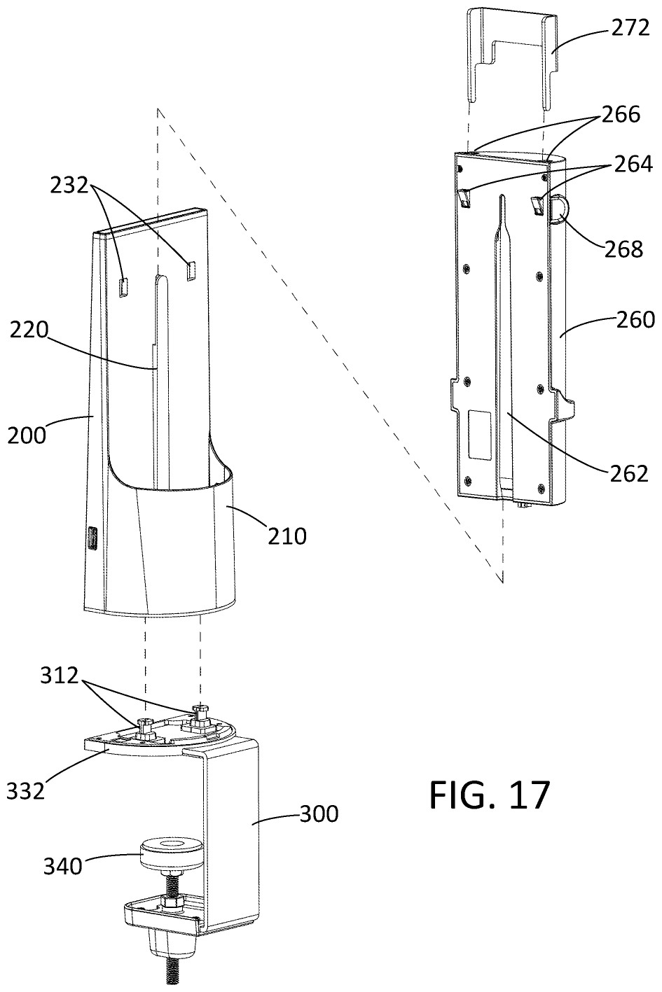

Turning now to FIG. 17, the figure shows an expanded view of the invention 100 presenting the connection order and orientation of the display mount 300, the display unit 200 and battery well 210, the battery 260, and the battery release key 272. The display mount 300 may be clamped to a mounting surface such that a moveable jaw 340 presses against the bottom of the mounting surface and a top alignment guide 332 and a pair of security posts 312 are positioned above the mounting surface. A display unit 200 may couple to the top of the mount 300. A battery 260 may detachably couple to the display unit 200 by lowering the battery 260 into a battery well 210 such that a guide rail 220 on the display unit 200 engages a guide slot 262 on the battery 260 and guides the battery 260 down into position. The battery 260 may lock into position as a pair of locking tabs 264 on the battery 260 pivot into battery lock apertures 232 on the display unit 200. A user may hold the battery 260 by a pair of finger handles 268 while installing and removing the battery 260. The battery 260 may conceal the mechanism that couples the display unit 200 to the mount 300 when the battery 260 is installed into the battery well 210 and locked into place. To release the battery 260 for removal, a battery release key 272 must be pressed into a pair of release apertures 266 on the top of the battery 260 to pivot the pair of locking tabs 264 out of the battery lock apertures 232. Note that in FIG. 17, the battery 260 is shown rotated about a vertical axis to show features of the front of the battery 260 in this exploded view.

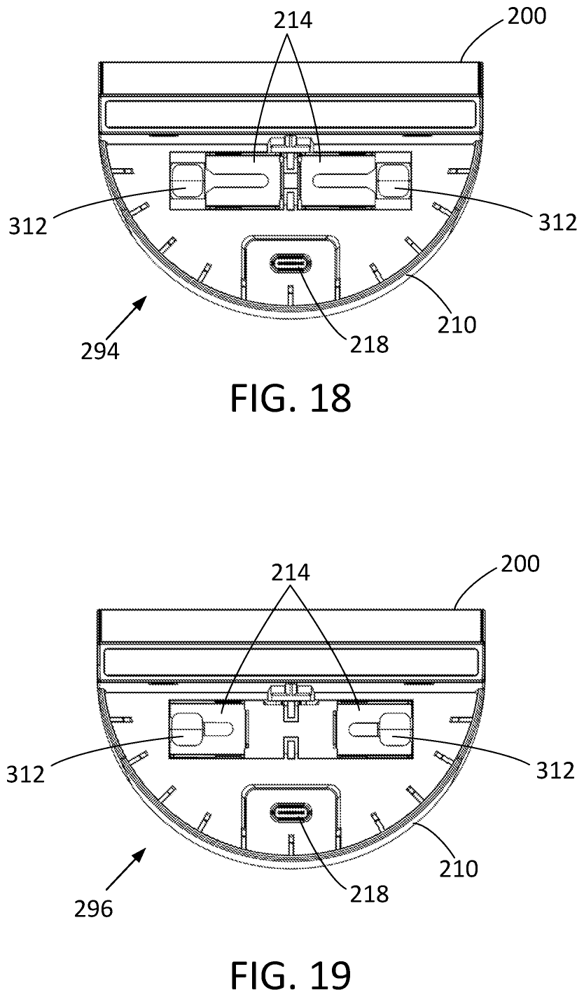

Turning now to FIG. 18, the figure shows a top view of a display unit 200 illustrating a pair of mounting clips 214 in a clip unlocked position 294. A pair of security posts 312 entering a battery well 210 through the bottom of the battery well 210 may be free to slide in and out of the battery well 210. While in the clip unlocked position 294, the pair of mounting clips 214 do not interfere with vertical movement of the pair of security posts 312. A first power connector 218 can be seen at the rear of the battery well 210.

Turning now to FIG. 19, the figure shows a top view of a display unit 200 illustrating a pair of mounting clips 214 in a clip locked position 296. A pair of security posts 312 entering a battery well 210 through the bottom of the battery well 210 may be retained by the pair of mounting clips 214. While in the clip locked position 296, the pair of mounting clips 214 may prevent the pair of security posts 312 from pulling down through the battery well 210. A first power connector 218 can be seen at the rear of the battery well 210.

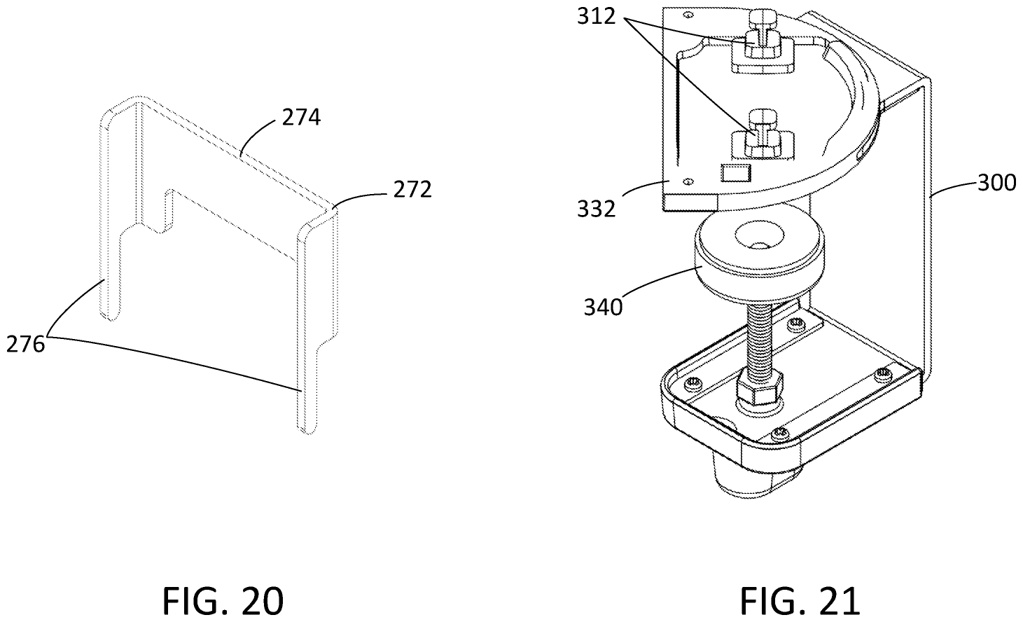

Turning now to FIG. 20, the figure shows an isometric view of a key 272. The key 272 may comprise a pair of release pins 276 coupled to each other by a crossbar handle 274. The pair of release pins 276 of the key 272 may be inserted into a pair of release apertures on the top of the battery to pivot a pair of locking tabs into the battery. The pair of release pins 276 are required so that a single pin inserted into the top of the battery is not sufficient to unlock the battery.

Turning now to FIG. 21, the figure shows an isometric view of an alternative embodiment of a mount 300. A top alignment guide 332 and a pair of security posts 312 may be rotated about a vertical axis to an off-center viewing angle, in this case by 45 degrees, to alter the viewing angle to patrons in some installations. The off-center viewing angle may be any angular measurement and may be oriented to the left or to the right of center. A moveable jaw 340 remains unchanged and may press against the bottom of a mounting surface directly below the top alignment guide 332.

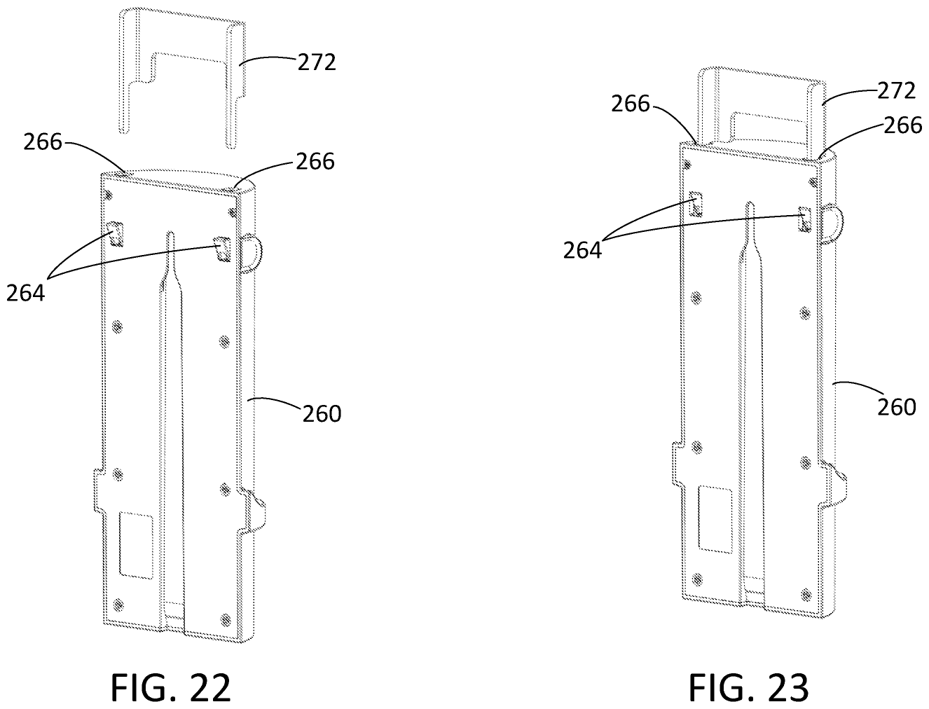

Turning now to FIG. 22, the figure shows an isometric view of a battery 260 illustrating a key 272 removed from the battery 260. With the key 272 removed from a pair of release apertures 266, a pair of locking tabs 264 may pivot out of the battery 260 to lock the battery 260 in place.

Turning now to FIG. 23, the figure shows an isometric view of a battery 260 illustrating a key 272 inserted into the battery 260. With the key 272 inserted into a pair of release apertures 266, a pair of locking tabs 264 may pivot into the battery 260 to unlock the battery 260 for removal.

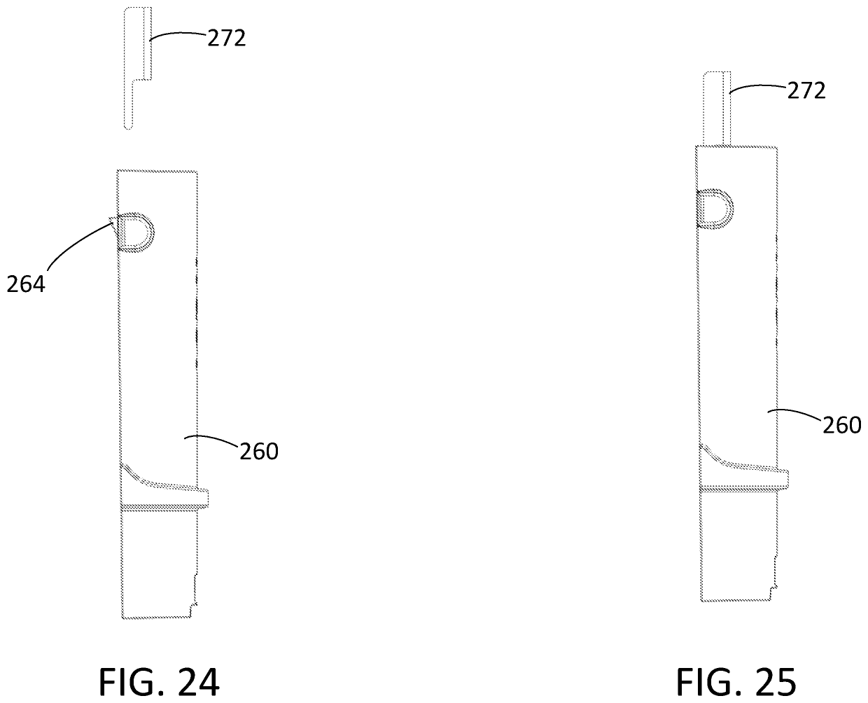

Turning now to FIG. 24, the figure shows a side view of a battery 260 illustrating a key 272 removed from the battery 260. With the key 272 removed from a pair of release apertures, a pair of locking tabs 264 may pivot out of the battery 260 to lock the battery 260 in place.

Turning now to FIG. 25, the figure shows a side view of a battery 260 illustrating a key 272 inserted into the battery 260. With the key 272 inserted into a pair of release apertures, a pair of locking tabs may pivot into the battery 260 to unlock the battery 260 for removal.

While certain illustrative embodiments have been described, it is evident that many alternatives, modifications, permutations and variations will become apparent to those skilled in the art in light of the foregoing description.

What is claimed is:

1. A system comprising:
a device having a display unit, a battery, a communications channel, and a mount;
where said display unit and said battery are securely coupled to said mount to form a secure content display system for interaction with one or more users when said mount is attached to a surface;
said display unit having a battery cradle for insertion of said battery, and mounting clips configured in the base of the display unit for secure attachment to said mount;
where said battery cradle further comprises a plurality of locking apertures to permit the battery to be securely attached to said display unit when battery is fully inserted in said cradle;
where said display unit further comprises a light bar at the upper surface of said display unit and a screen display to present service conditions and content to any user;
said display unit active to communicate with a data server to send and receive content, commands, instructions, and other displayable information;
said display unit providing an interaction capability between said data server and any user in response to displayed content, instructions, and other displayable information;
said display unit accepting information and providing said interaction capability with any user to provide service, provide information, and present interactive content to said user.

2. The system of claim 1, further comprising
where a pair of security posts on the mount pass through mounting apertures in a battery well of the display unit;
where a pair of mounting clips in the battery well slide to a clip locked position on the pair of security posts to secure the display unit to the mount;
where the pair of mounting clips are covered by the battery and are inaccessible for sliding when the battery is coupled to the display unit.

3. The system of claim 1, where said plurality of locking tabs are spring-loaded and engage battery lock apertures of said battery cradle.

4. The system of claim 3, where said plurality of locking tabs release when a locking tab key is inserted into a top portion of the casing of said battery, releasing said spring-loaded locking tabs from said battery lock apertures.

5. The system of claim 1, where said communications channel comprises one or more wireless transceivers;
where the one or more wireless transceivers comprise at least one Wi-Fi transceiver for wirelessly communicating with said data server or an existing business infrastructure having wireless capability.

6. The system of claim 5, where the one or more wireless transceivers communicate through one or more NFC communication protocols.

7. The system of claim 1, where said light bar is illuminated, extinguished, changes intensity, changes color, blinks, or any combination thereof to indicate a command, communicate status information, or indicate a state of the display unit or battery.

8. The system of claim 1, where the display unit is configured to display content comprising static images, motion video, advertising messages, games, contests, surveys, or any combination thereof.

9. The system of claim 1, further comprising control and command software algorithms to manage content, provide command and control, and manage the communication and interaction between said device and said data server.

10. The system of claim 1, further comprising one or more USB ports;
where said USB ports are adapted to be accessible to users for use in recharging personal devices owned by said users.
